(19) United States
(12) Patent Application Publication
(10) Pub. No.: US 2004/0107142 A1
(43) Pub. Date: Jun. 3, 2004

(54) Slales assistance system and method thereof with using computer network

(76) Inventors: Kouki Tomita, Tokyo (JP); Naoto Uchida, Ageo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/805,191

(22) Filed: Mar. 14, 2001

(30) Foreign Application Priority Data
Apr. 5, 2000 (JP) 2000-108018

(51) Int. Cl. G06F 17/60

(52) U.S. Cl. 705/26

(57) ABSTRACT

A sales assistance system and method which allows a user to buy goods from stores near the user without directly purchasing the goods on a computer network. The system includes a server connected to a plurality of client terminals through the computer network. The server inputs a request to buy goods, including address information of the user, a memory device which stores information concerning the goods and the stores handling thereof in advance therein; and a controller which searches out stores from the information stored in the memory device based on the address information, and displays the stores on the client terminal. The client terminal selects one of the stores displayed and transmits the request to the selected store to, for example, a facsimile machine of the store or the like.

### BACKGROUND OF THE INVENTION

The present invention relates to a sales assistance system with using a computer system therein, being convenient for a customer, in which to a customer who wishes to buy consumer goods or commodity is introduced a store or a shop, which handles those through the Internet, for example, as a representative example of the computer networks.

Conventionally, many systems are already well-known which enable to buy or purchase consumer goods or commodity through the Internet, as is the representative one of the computer networks, (i.e., so called, the Internet sales, electronic commerce, etc.), for example, Amazon.com, in relation with purchasing of books or publications, etc., and they are already practiced and used widely because of convenience thereof.

Also, a method and so on for supplying advertising information through the computer network is already known, for example in Japanese Patent No. 2,756,483.

However, with the conventional arts mentioned in the above, there are still pointed out problems as mentioned below. Namely, though such the Internet sales (i.e., a direct purchase method) is suitable in United States of America where the land is wide and then mail-order business has been developed, the situation is different therefrom, in particular in Japan, where many stores or shops are located around the customers. This is based on a fact that the customers in Japan have strong tendency of purchasing goods by checking them by themselves, accordingly, although being suitable for via the electronic commerce but there are still remained many goods or commodity which a people believes better to buy at the stores or shops, such as the products by mass production.

Also, though being high in the convenience for the customers since what she/he has to do is only clicking a “purchase” button on the conventional Internet sales, on the contrary to this, there are still many customers who feel anxiety about the purchases through such the Internet sales, and further, through on such the Internet sales, she/he must make a request or order again to a plumber or a businessman who undertakes installation of the product after arriving thereof, in a case of, such as a room air conditioner which accompanies work of the installing together with the purchase thereof, therefore it is very inconvenient comparing to the conventional mode of sales, through which she/he could make the purchase of the product, as well as the order of the installation work thereof through that store or shop which she/he purchase it.

Namely, it is difficult to replace all the existing sales systems of goods or commodity by the Internet sales and/or the electronic commerce, etc., of the above-mentioned conventional arts, and then a system is strongly required, which is most suitable, appropriately corresponding to the needs of users (or the customers) and regional factors, with using the computer network therein.

### SUMMARY OF THE INVENTION

Then, an object according to the present invention, for dissolving the problem(s) of the conventional arts mentioned above, is to provide a sales assistance system and also a method thereof with using the computer network therein, being completely new and different from the conventional ones, in particular upon the basis of an intention of the customers or consumers who still wish to buy the goods or commodity after checking them through stores or shops which are located in their neighborhood, but not buying them directly on the computer network as was mentioned in the above.

For achieving the object mentioned above, according to the present invention, there is provided a sales assistance system, being connected with a plurality of client terminals through a computer network, comprising: a communication means, being connected with said computer network, for inputting a goods purchase request information including a customer address relating information from said client terminals; a memory device for storing at least a goods/store information including the goods and the stores which deal with those goods; and a controller portion for searching a plurality of stores from the goods/store information stored in said memory device, upon said customer address relating information which is inputted through said communication means, so as to display them on one of said client terminal, as well as for detecting the store which is selected by the customer, among those plural stores, so as to transmit the goods purchase request information which is inputted from said client terminal to said store which is detected.

Also, for achieving the object mentioned above, according to the present invention, there is provided a sales assistance method for assisting sales of goods, with using a computer system, being connected with a plurality of client terminals through a computer network, and comprising a memory device for storing at least a goods/store information including the goods and the stores which deal with those goods, in advance, and a controller portion, comprising the following steps: a step for inputting purchase request information including a customer address relating information from any one of said client terminals; a step for searching a plurality of stores which are dealing with said goods, from the goods/store information stored in said memory device, upon said customer address relating information which is inputted, so as to display them on said client terminal; a step for detecting the store which is selected by the customer on said client terminal, among those plural stores; and a step for transmitting the goods purchase request information which is inputted from said client terminal to said store which is detected.

Further, according to the present invention, there is provided the sales assistance system as described in the above, wherein a number n of the plural stores which are searched and displayed upon the basis of said customer address relating information lies within a range from being equal or greater than ten and being equal or less than twenty (10<n <20), wherein further, said controller portion comprises any one of a facsimile modem, a facsimile apparatus and an electronic mail device, as the means for transmitting the inputted goods purchase request information to said store which is detected, or wherein the goods/store information which are stored within said memory device 20 includes video information of the goods which the store are handling.

### BRIEF DESCRIPTION OF THE DRAWINGS

The scope of the present invention will be apparent from the following detailed description, when taken in conjunction with the accompanying drawings, and such detailed description and specific examples, while indicating example embodiments of the invention, are given by way of illustration only, since various changes and modifications within the spirit and scope of the invention will become apparent to those skilled in the art from this detailed description in which:

FIG. 1 is a view of showing a total configuration of a sales assistance system with using a computer network therein, according to an embodiment of the present invention;

FIG. 2 is a view for showing the detailed construction of a sales assistance server, in the above-mentioned sales assistance system according to the present invention;

FIG. 3 is a view for showing an example of a customer file which is used in the above-mentioned sales assistance system according to the present invention;

FIG. 4 is a view for showing an example of an item file of goods, which is used in the above-mentioned sales assistance system according to the present invention;

FIG. 5 is a view for showing an example of a store file, which is used in the above-mentioned sales assistance system according to the present invention;

FIG. 6 is a view for showing an example of an order receipt file of goods, which is used in the above-mentioned sales assistance system according to the present invention;

FIG. 7 is a part of a flow chart for explaining an operation of the above-mentioned sales assistance system according to the present invention, in particular an order receipt processes thereof (a part one (1));

FIG. 8 is also a part of the flow chart for explaining the operation of the above-mentioned sales assistance system according to the present invention, in particular the order receipt processes thereof (a part two (2));

FIG. 9 is also a part of the flow chart for explaining the details of a customer information register process in the above-mentioned order receipt processes (a part three (3));

FIG. 10 is a flow chart for explaining the details of a store search process in the above-mentioned order receipt processes;

FIG. 11 is a flow chart for explaining the operation of the above-mentioned sales assistance system according to the present invention, in particular, of an order transmission process thereof;

FIG. 12 is a view of showing an example of a screen for selection of the goods or commodity to be purchased, which is used in the above-mentioned order receipt processes;

FIG. 13 is a view of showing an example of a screen for displaying a list of recommendable goods, which is used in the above-mentioned order receipt processes;

FIG. 14 is a view of showing an example of a display screen including a video information containing an outlooks of the goods or commodity, which is used in the above-mentioned order receipt processes;

FIG. 15 is a view of showing an example of a screen displayed for prompting the customer to make an input of a password which was given to her/him, which is used in the above-mentioned order receipt processes;

FIG. 16 is a view of showing an example of a screen for store search (selection), which is used in the above-mentioned order receipt processes;

FIG. 17 is a view of showing an example of an order receipt confirmation screen, which is used in the above-mentioned order transmission processes; and

FIG. 18 is a view of showing an example of a purchase order application for good s or commodity, which is used in the above-mentioned order transmission processes.

### DETAILED DESCRIPTION OF PREFERRED EMBODIMENT(S)

Hereinafter, embodiments according to the present invention will be fully explained by referring to the attached drawings.

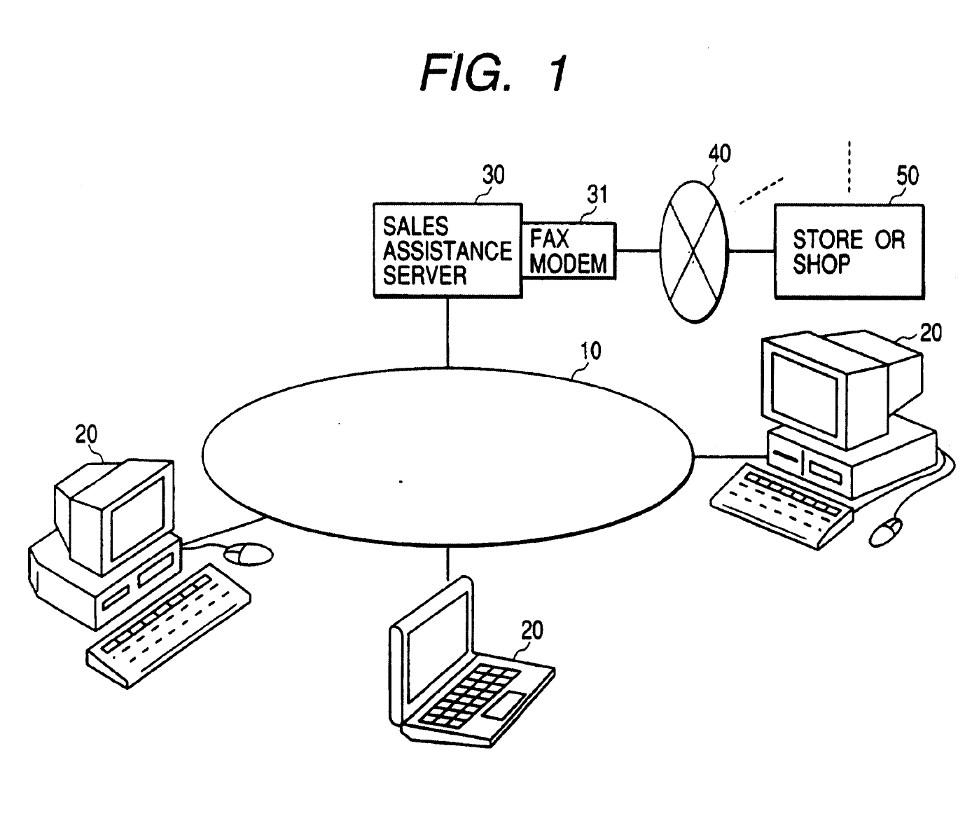

First of all, FIG. 1 shows the total configuration of a sales assistance system with using a computer network therein, according to an embodiment of the present invention.

In the FIG. 1, wherein a reference numeral 10 indicates a computer network, which may be represented by the Internet, a plurality of client PCs (client terminals) 20, 20..., each of which may be formed with a personal computer, for example, are connected to this computer network 10, while also to the computer network 10 is connected a sales assistance server 30 which constructs the sales assistance system, according to the present invention. Further, this sales assistance server 30 comprises a facsimile modem 31, which is connected to a plural number of stores or shops 50 through a telephone circuit 40, etc.

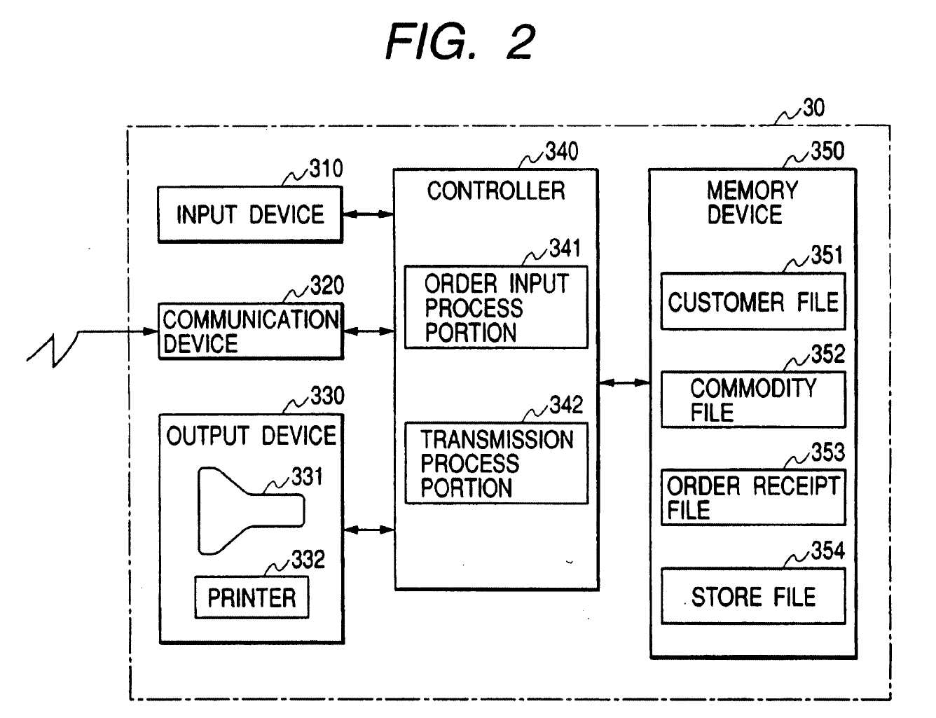

Next, the detailed construction of the above-mentioned sales assistance server 30 is shown in FIG. 2. Namely, the sales assistance server 30 includes an input device 310, such as a keyboard, a mouse, etc., a communication device 320, which may be constructed with a modem, etc., for conducting the communication of information among the client PCs 20, 20 ... through the above-mentioned computer network 10, and an output device 330. Further, this output device 330 comprises a display device 331, being constructed with, such as a CRT or a LCD, etc., for displaying a video output of the above-mentioned sales assistance server 30, and a printer device 332 for outputting the output thereof on a paper, for example.

The above-mentioned input device 310, the communication device 320 and the output device 330 are connected to a controller 340 which is constructed with a CPU (Central Processing Unit) or the like, for example, respectively, while this controller 340, the details of which will be explained later, comprises an order input process portion 341 for inputting an order from a customer, so as to make an introduction of dealing stores or shops, and a transmission process portion 342 for transmitting the contents of the purchase order to the store or shop that is selected by the customer from the dealing stores or shops being introduced to her/him, etc. Also, to this controller 340 is connected a memory device 350, which may be constructed with various kinds of memory devices, through a data bus, etc.

Although various kinds of information are inputted into this memory device 350 and/or are memorized therein, as is shown for example in the FIG. 2, they include a customer database 351, a commodity database 352, an order receipt database 353, and a store database 354, etc., details of which will be explained later.

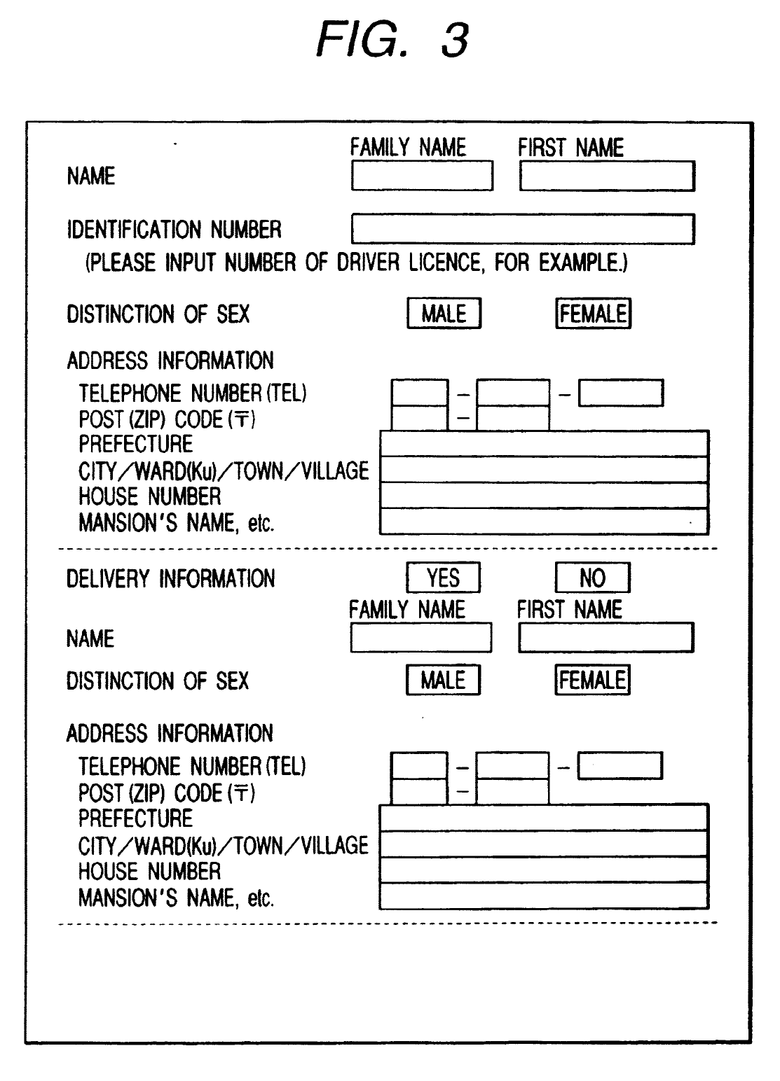

Next, detailed explanation will be given on an example of the customer file which is inputted and memorized into the above-mentioned customer database 351, by referring to FIG. 3. However, this customer file is an electronic information, which is inputted through the client PC (the client terminal) 20 of the client when the customer uses the sales assistance system of the present invention at first, to be memorized into the above-mentioned memory device 350.

As is apparent in the FIG. 3, the customer who uses the sales assistance system of the present invention, inputs her/his name (i.e., family name and her/his name) and then figures or marks of her/his identification number (for example, the number of her/his driver license or the number of her/his passport may be possible to be inputted) through the input device, such as the keyboard. Further, the distinction of sex (i.e., “male” or “female”) is selected through clicking on it, by means of such as a mouse, and then an address information is inputted.

This address information (a customer address relation information) includes, in addition to the address of the customer, a telephone number(s) of the customer. Namely, after inputting her/his telephone number(s) into an item or column “Telephone No.” as shown in the figure, the customer is prompted further to input a necessary information into each of the items “Post (Zip) Code”, “prefectures (i.e., the largest administrative divisions or units of Japan)”, “City/Ward (or “Ku” in Japanese)/Town/Village”, and “House No.”, etc. Also, depending upon the necessity thereof, into the item “Name of Mansion, etc.” can be inputted the name and/or the room number of the mansion, apartment building or condominium, where she/he lives in or occupies by her/himself.

And, basically, the customer information mentioned above comes to be inputted into the above-mentioned customer database 351 as the customer file, so as to be memorized therein. However, there can be a case, for example where the goods which the customer purchased should be delivered to another place (address) being different from the address of the customer that was inputted in the above. Then, according to the sales assistance system of the present invention, in addition of the customer information mentioned above, the customer can input a delivery address information, depending upon the necessity thereof.

Namely, after first selecting on whether there is such the delivery address information or not (i.e., Yes or No) through the clicking thereon, the customer can input the address of delivery and/or the necessary address information, in the same manner as mentioned in the above. However, being different from the above-mentioned customer information, this delivery information is memorized, not into customer database 351 mentioned above, but into the order receipt database 353 which will be explained later.

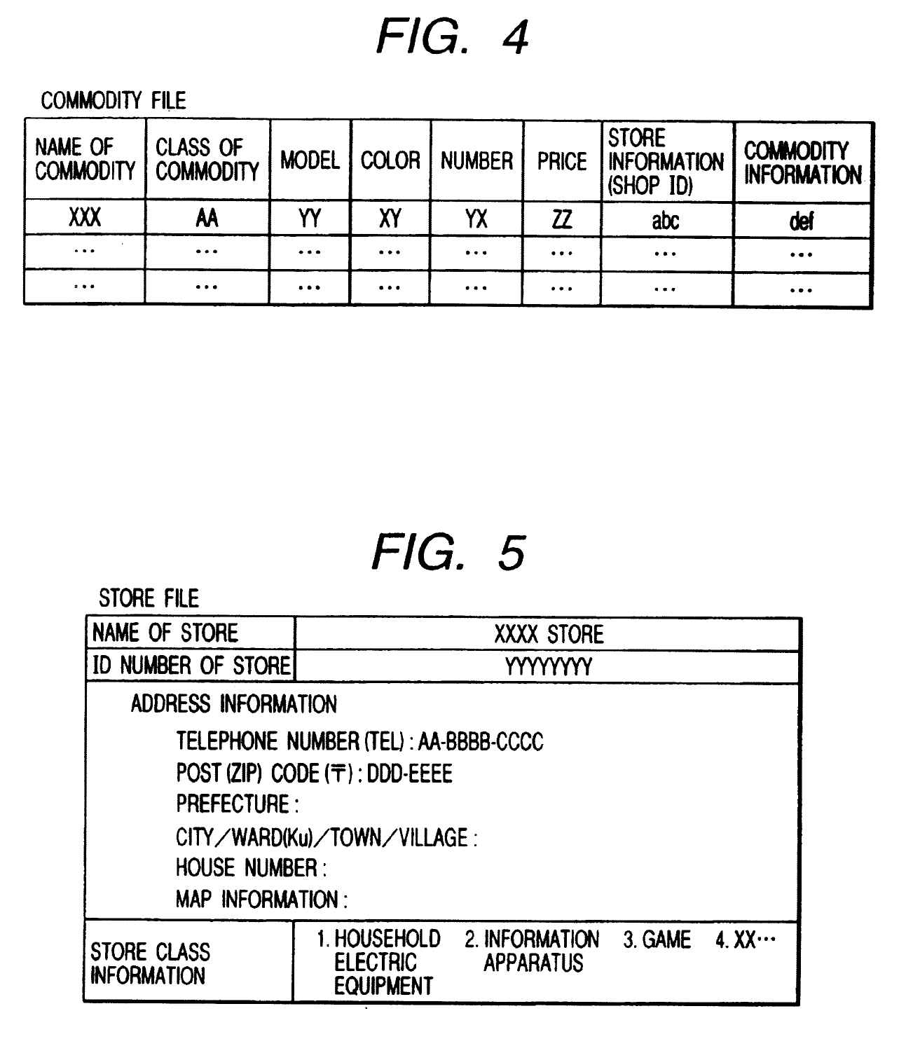

Next, explanation will be given on the commodity file, being the information that was memorized in the commodity database 352 within the memory device 350 in advance, by referring to FIG. 4 attached. Namely, in this commodity file are inputted and memorized the information about all goods or commodities, which are handled or dealt by the stores or shops registered in the sales assistance system of the present invention, in advance. In more details, in this commodity file are memorized product names, classes or groups of the products, model numbers, colors, the number of the products in stock, prices thereof, and information about the stores which handle those products, in a predetermined format.

Into the items of the above-mentioned class or group of product, as an example, so-called “household electric appliance” is inputted for, such as a washing machine, a refrigerator, a room air-conditioner, etc., “information apparatus” for a personal computer and the peripheral apparatuses thereof, or “game” for a game player and game software therefor, respectively, by a code or a number corresponding thereto, for example. Also, as the information of stores mentioned above, it is possible to input the names of the stores directly, however from a view point of processing of information, it is preferable to input them by means of shop IDs, each being given to the stores which joined or gain memberships of the sales assistance system of the present invention, respectively. Also, as the information about the goods or commodity mentioned above, in addition to the sizes and performances of the product, it is also possible to include a video information (including a moving picture) including an outlook of that product. Further, the video information including the outlook of the product may be an interactive one.

However, this commodity file can be inputted from the input device 310 at the side of the above-mentioned sales assistance server 30, and for example, when the goods or commodities which the above-mentioned store handles are changed over, the information of the commodity file will be changed over corresponding thereto, for a maintenance thereof.

Next, explanation will be given on the so-called store file, which is the information memorized in the store database 354 within the above-mentioned memory device 350, by referring to FIG. 5 attached. Also this store file, in the same manner as the above-mentioned commodity file, is the information which is inputted at the side of the above-mentioned sales assistance server 30 and is maintained therein, and it is inputted for each of the stores which are registered or joined into the sales assistance system, in advance, and is memorized therein. Also, in a case when a store joins newly, or when a store secedes from the present system, a renewal will be conducted at the side of the above-mentioned sales assistance server 30, i.e., the information of this store file is changed or altered, so as to make the maintenance therefor.

In this store file, as shown in the FIG. 5, are included “Store Name”, “Store ID (i.e., the shop ID mentioned above)”, “Address Information” and “Shop Class Information”, etc. Further, in the above-mentioned address information, there are included “Telephone No.”, “Post (Zip) Code”, “prefectures”, “City/Ward(or “Ku”)/Town/Village”, and “House No.”, etc., of each of the stores, and further, in addition to those items, there can be included a map information indicating the neighborhood of the seat of that store (furthermore, the video information of the neighborhood (including the moving picture thereof) may be included), for example. Also, in the item of the above-mentioned shop class information, the goods or commodities which that shop are handling are inputted by means of the above-mentioned class information of commodities, in relation with the commodity file mentioned above.

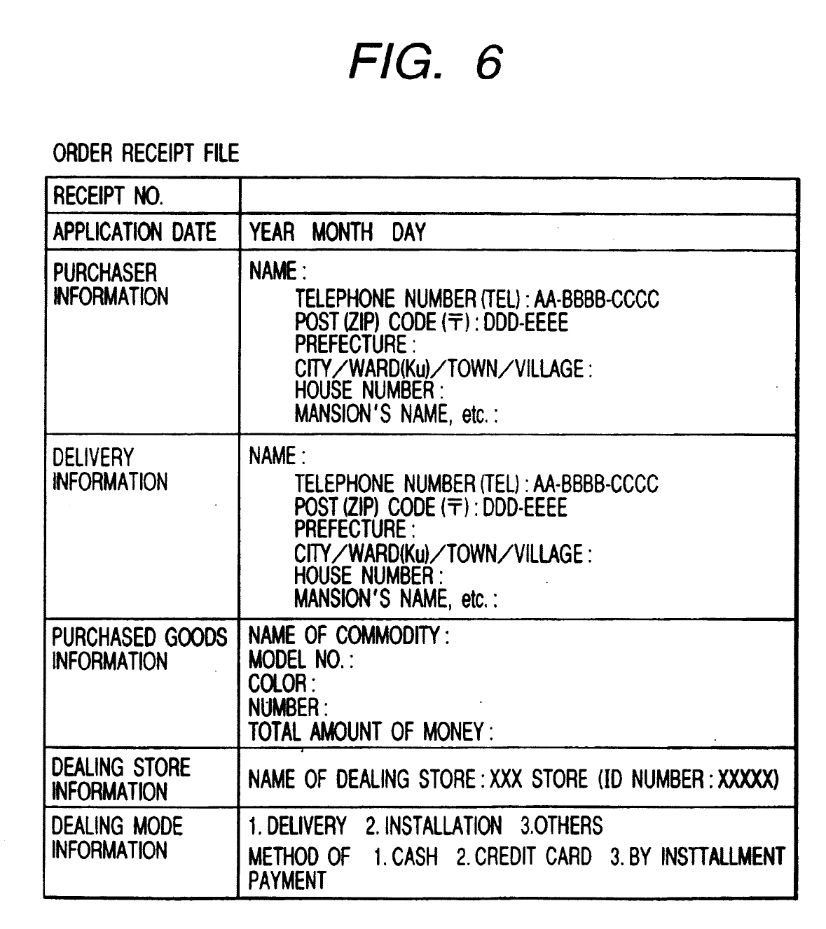

And, explanation will be given on the order receipt file which is inputted and memorized into the order receipt database 353 within the above-mentioned memory device 350, by referring to FIG. 6 attached. However, this order receipt file is produced at the side of the above-mentioned sales assistance server 30 when the customer decides or determines the dealing store handling the goods or commodity which she/he wish to buy.

This order receipt file, as is apparent from the figure, includes such items, “Receipt No.” and “Application Date”, and further items, “Purchaser Information”, “Delivery Address Information”, “Purchased Goods Information”, “Dealing Store Information” and “Dealing Mode Information”. However, being extracted from the customer file mentioned in the above (see the FIG. 3) depending upon the necessity thereof, the information of the item of “Name” and the address information thereof are inputted into the item of “Purchaser Information”. Also, regarding the item of “Delivery Address Information”, the necessary information is extracted depending upon the existence of the delivery address information, which is inputted on the customer file shown in the FIG. 3, and it is inputted.

Further, into the above-mentioned “Purchased Goods Information”, information relating to the necessary items, being extracted by referring to the commodity file shown in the FIG. 4 mentioned above, is inputted about the goods or commodity which the customer indicates her/his wish to buy, in the operation processes (i.e., on a commodity selection screen) which will be explained below. Also, into the “Dealing Store Information”, information relating to the necessary items, being extracted by referring to the store file shown in the FIG. 5 mentioned above, is inputted about the store which is selected by the customer, from the operation processes (i.e., on a store selection screen) which will be explained below. Also, in the item “Dealing Mode Information” are inputted information about the customer's desire(s) upon, such as “delivery” and/or “installation” of the product(s). And in “Method of Payment” is inputted one on which the customer desires.

Following to the above, explanation will be given on an operation of the sales assistance system according to the present invention, the detailed structure of which was explained in the above, by referring to the drawings attached.

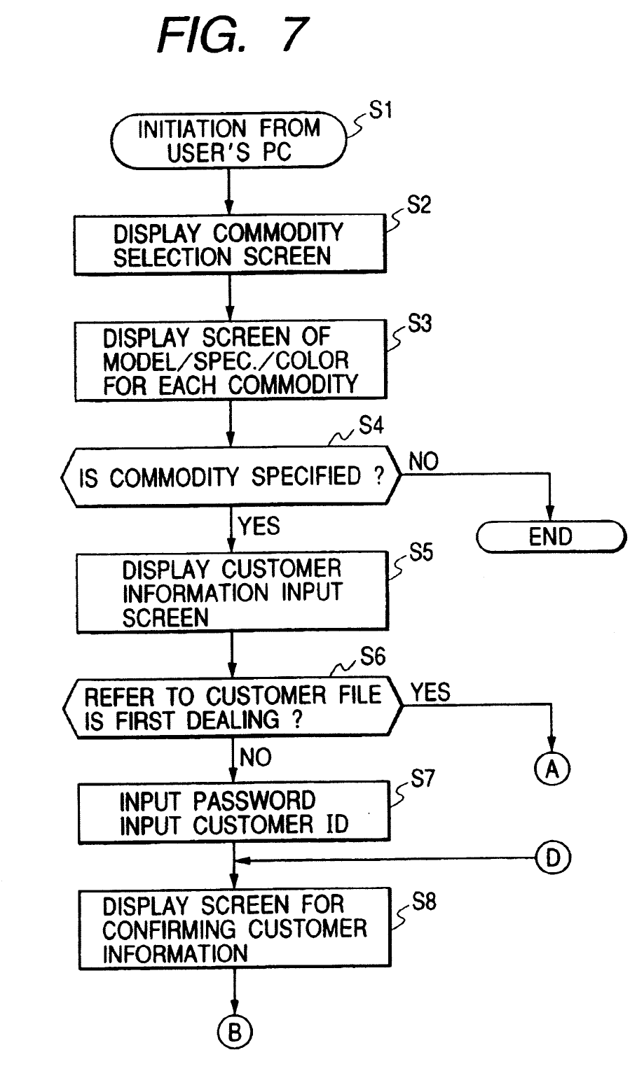

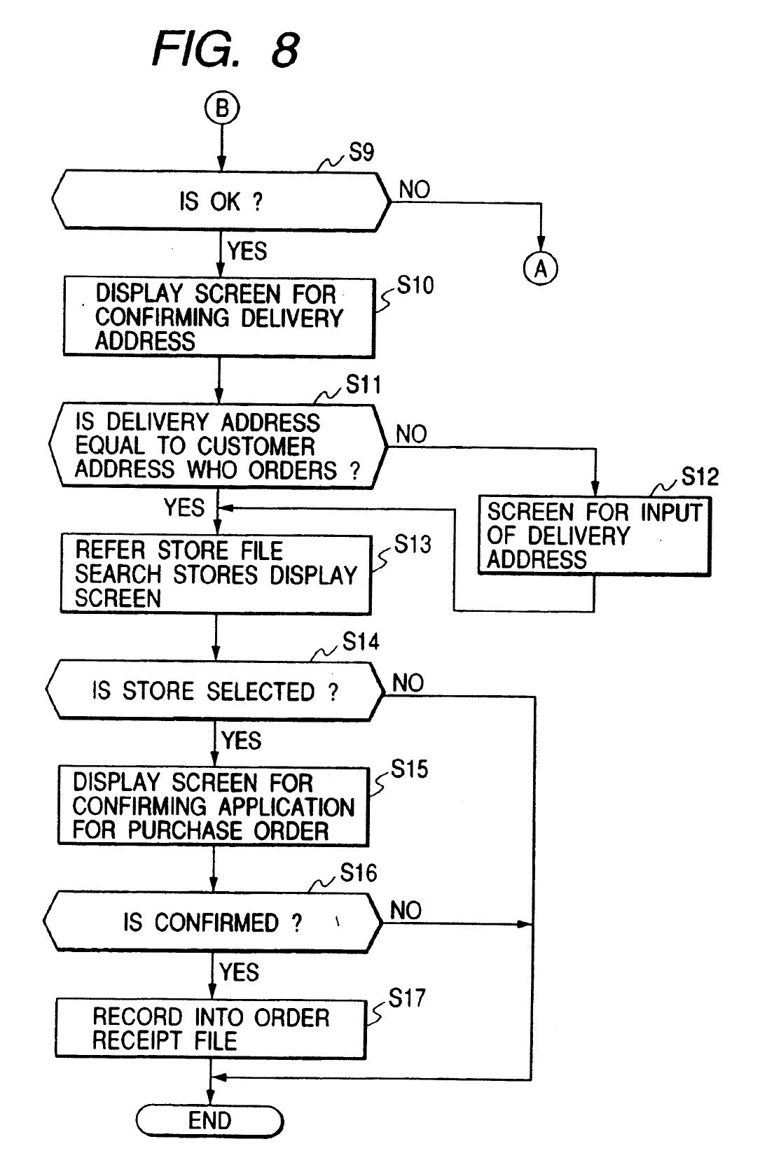

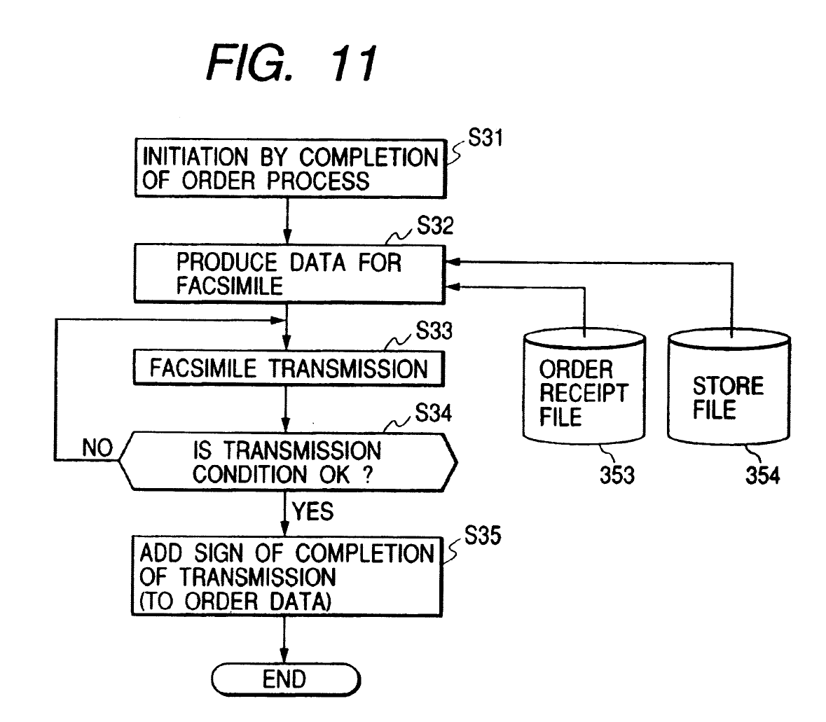

However, the operation which will be explained in details below is conducted between the above-mentioned sales assistance server 30 and the client PCs 20 which are connected to it through the computer network 10. Further, in FIGS. 7 to 10 is shown a flow chart for order receipt processes, and in FIG. 11 a flow chart of order transmission processes.

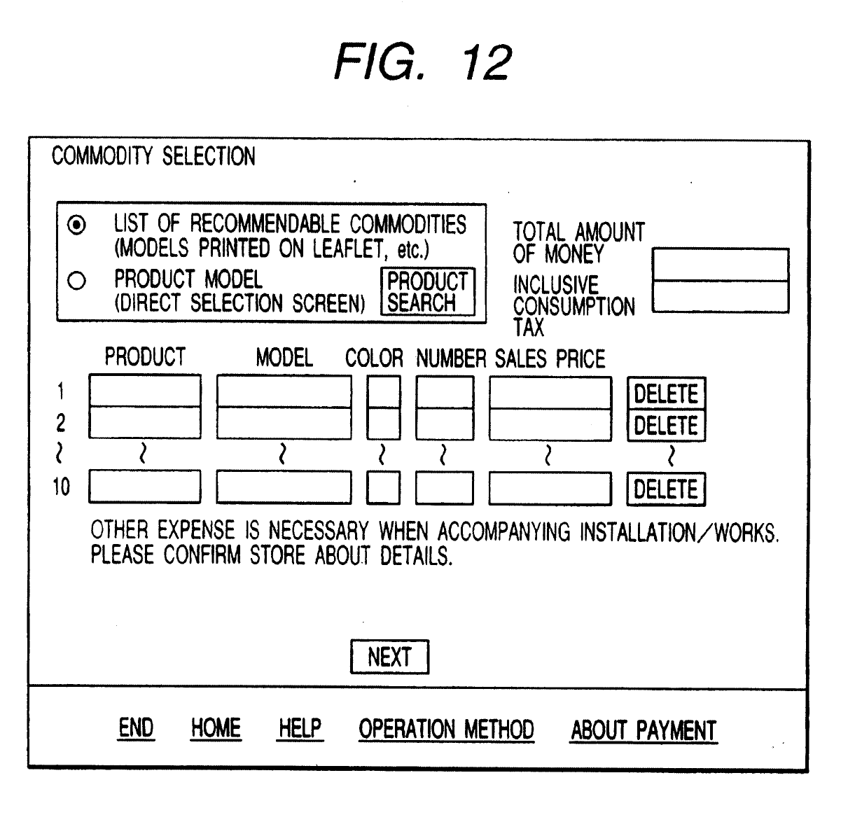

First, in the order receipt processes, as shown in FIG. 7, when an initialization is made from the client PC as the user terminal (customer terminal), the operation thereof is started or initiated thereby (step S1). Following to this, a commodity selection screen is displayed on the output screen of the client PC 20 (step S2). An example of this commodity selection screen is shown in FIG. 12 attached.

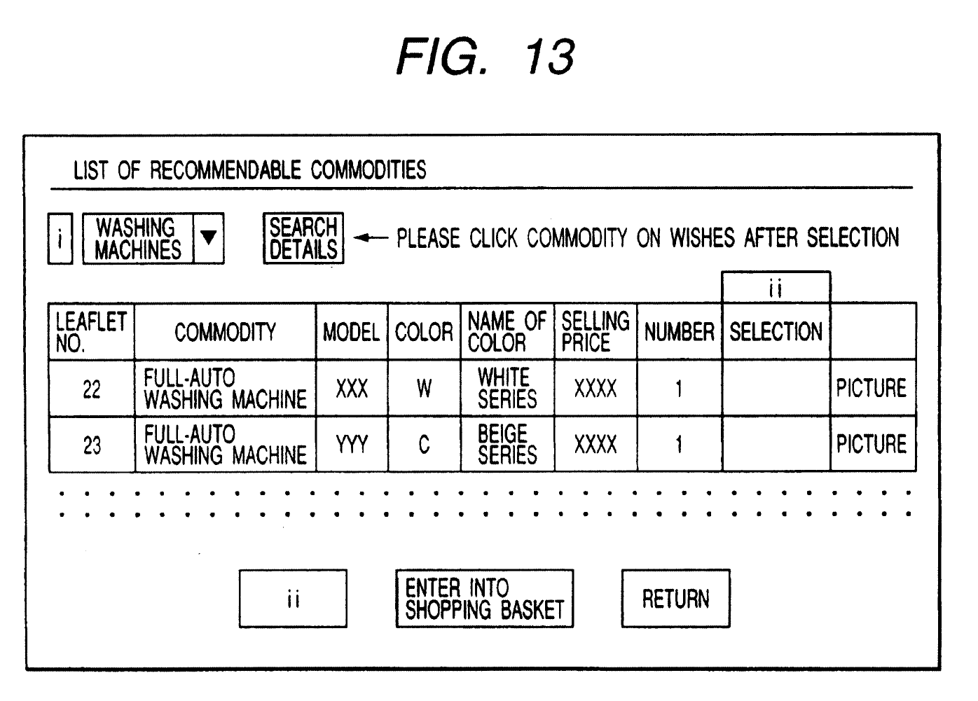

As is apparent from the figure, either one of “List of Recommendable Goods” or “Product Model (direct selection screen)” is selected through clicking on “O” shown in the figure by the user, as a selecting method of the goods or commodity. In FIG. 13 is shown an example of this display, when the “List of Recommendable Goods” is selected to be displayed, wherein the user selects the goods or commodity which she/he wishes to buy on this screen.

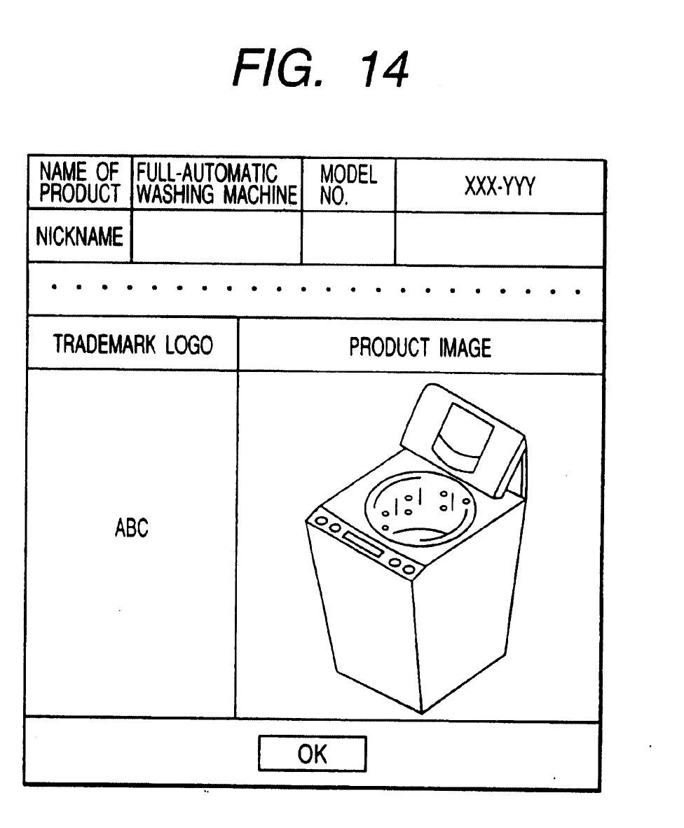

Explaining further in details of this screen of the “List of Recommendable Goods”, the user selects the type of the goods or commodity (for example, “washing machine”, etc.) from a drop-down indicated by “I” in the figure, and then clicks on “Search Detail” which is positioned at the right-hand side thereof, thereby displaying a list of machine types which is indicated in a central portion of the figure (step S3). However, this list of machine types is extracted appropriately from the commodity file (see the FIG. 4) which is memorized in the commodity database 352 within the above-mentioned memory device 350, so as to be displayed thereon. Due to this, the user as the customer is able to select the goods or commodity at her/his desire, freely. However, when clicking on “Picture” at an end of the right-hand side of the list of machine types, she/he can display the video information including the outlook of the goods or commodity selected, as well as the sizes and performances of thereof, which are memorized as the commodity information in the above-mentioned commodity file. An example of the displayed screen including this video information is shown in FIG. 14 attached.

Further, after designating the commodity through clicking on the screen of the “List of Recommendable Goods” shown in the FIG. 13, the selection of commodity is conducted by clicking on “ii. Enter into Shopping Bag or Cart” in a lower portion of the screen (i.e., “√” is inputted into the item “ii. Selection” on the list in the figure), and at the same time, it is displayed on the list which is indicated in the center of the commodity selection screen shown in the FIG. 12 mentioned above. Also, in this selection of goods or commodity to be purchased, the number of the goods or commodities which the customer wishes to buy, and so on, may be inputted depending upon the necessity thereof. However, after the selection thereof, it is also possible to delete the goods or commodity which was once selected to be purchased, through clicking on “Delete” at an end of the right-hand side of the list.

After the screen display process (step S3) about the model/specification/color etc., for each of the goods or commodities mentioned above, it is decided whether the goods or commodity is identified by the user or not (step S4) in the flow of the processes. As a result of this decision, if it is decided that the goods or commodity is not yet decided (i.e., being decided to be “NO”), the process is completed or finished, on a while if being decided that the goods or commodity is decided (i.e., “YES”), the customer information screen is displayed on the client PC 20, thereby prompting the input thereof (step S5). Namely, displaying the customer file shown in the FIG. 3 mentioned above on the display screen of the client PC, it prompts the user to make inputs in each of the items thereof. However, for the user who already used the present sales assistance system before, it is enough (or enable to log in) that she/he inputs only her/his identification (ID) number registered, and/or the password or the like which was given previously, for example.

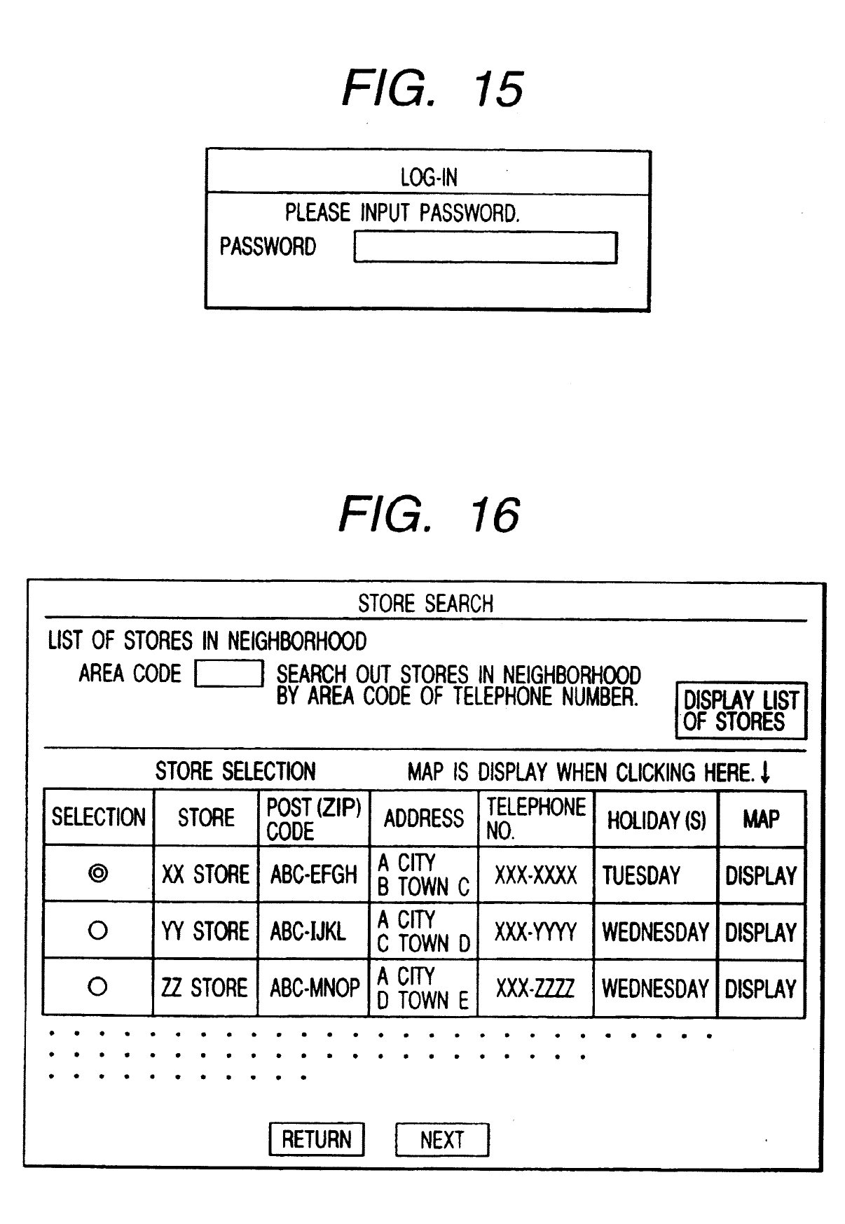

Namely, at the side of the sales assistance server 30, it is decided whether the dealing by that customer is a first one or not with using the present sales assistance system, by referring to the name (family name and name) of the customers and/or the identification numbers therefor which are inputted into the above-mentioned customer database 351 in advance (step S6). As a result of this, in a case where it is decided to be the first one (i.e., “YES”), the process is shifted into a flow (A) which will be explained later, thereby conducting the process for registration which will be explained later. On the other hand, in a case where it is decided that the dealing by he/him was already made previously (i.e., “NO”), the screen is displayed, which is shown in FIG. 15, for example, so as to prompt the customer to input the password or her/his name (or her/his own identification number) which was previously given to her/him (step S7). Thereafter, the screen for confirming the customer information is displayed by means of the customer file or the like which is shown in the FIG. 3 (step S8), and further this process flow proceeds into a flow (B) shown in the FIG. 8.

Following to the above, explanation will be given on the process flow (B) shown in the FIG. 8. Displaying the customer confirmation screen shown in the above-mentioned step S8 for prompting the customer to confirm the contents thereof by her/himself, it is decided whether the result of it is “OK” or not (step S9). As a result of this, in a case of deciding to be “NO”, the process flow is turned back to the flow (A) mentioned above. While in a case of deciding to be “YES”, the process flow displays the screen for confirming the delivery address which was mentioned in the above (for example, the delivery address information of the customer file shown in the above-mentioned FIG. 3), and then it decides whether the delivery address is coincide with the address of the customer who orders the purchase of the goods or commodity, or not (step S11). In this instance, the process is shifted to the next step (i.e., step S13) after displaying the delivery information of the customer file shown in the above-mentioned FIG. 3, again, so as to prompt the user to input thereto, in a case of deciding to be “NO”, while it is shifted directly thereto as it is, in a case of deciding to be “YES”.

In the step S13, the screen for searching (extracting) the dealing store, as shown in FIG. 16 attached for example, is displayed on the display screen of the client PC 20, by referring to the store file which is memorized in the store database 354 within the above-mentioned memory device 350. Namely, this store search screen is for the purpose of showing the stores or shops in the neighborhood by a list thereof, after searching them from the address of the customer or the delivery address, thereby to prompt the customer to select the store (i.e., the dealing store) from which she/he wishes to buy the goods or commodity. Herein, as shown in the figure, the numbers of upper four (4) digits thereof are automatically inputted into item “Area Code”, upon the basis the telephone number as the information of the customer file mentioned above, thereby conducting the search of the stores or shops in the neighborhood thereof, and the result of the search is displayed in the central portion of the display screen, as a selection list of the stores or shops.

In this selection list of the stores, a plural number of the stores or shops are displayed together with the items of their store's names, post (Zip) codes, addresses, telephone numbers, and days of week(s) of holiday(ies), etc., as those which can be selected by the customer being as the user. On the other hand, it is possible for the user to make the selection of store, by clicking on “o” in the item “Selection” at an end of the left-hand side of the list, on the display screen of the terminal device thereof. Also, at an end of the right-hand side of the list is disposed a button for displaying the map information of each of the stores or shops which are selectable for the user, so as to achieve the convenience in selection of the store by the user.

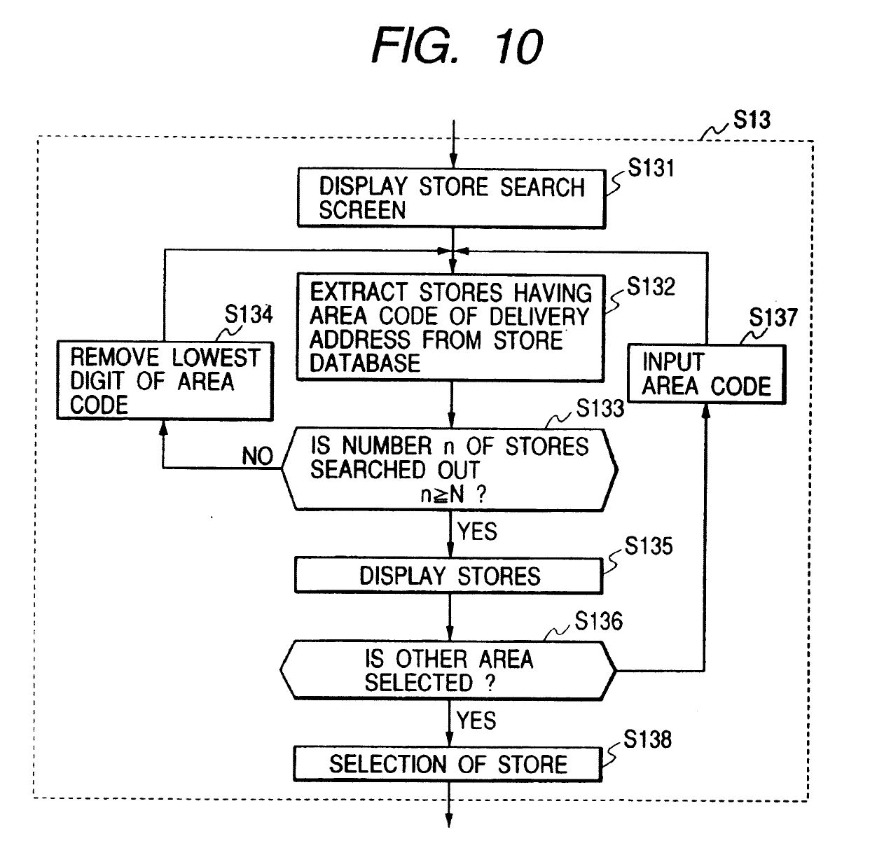

Further, the more details of this step S13 are shown in the FIG. 10 attached. Namely, the sales assistance server 30 displays the store search screen as shown in the above-mentioned FIG. 16 (step S131), and it searches (or extracts) the stores or shops having the area code (for example, the upper four (4) digits), being same to that of the address of the customer or the delivery address, upon the information which is inputted into the above-mentioned item of “Area Code”, from the store file, which is memorized in the store database 354 of the memory device 350 and an example of which is shown in the above-mentioned FIG. 5 (step S132). Next, it is decided whether the number (n) of the stores or shops which are searched in the step S132 mentioned above is equal to or larger than a predetermined number (N), or not (step S133). As a result of this, if it does not reach to the predetermined number (i.e., in the case where it is decided to be “NO”), after deleting one digit at the lowest of the area code therefrom (for example, reducing the upper four (4) digits into the upper three (3) digits) (step S134), the process turns back to the above-mentioned step S132, again, so as to search (extract) them from the store file.

Here, in common, the predetermined number (N) of the stores mentioned above, being selectable by the user, is preferable to be equal to or larger than ten (10), and be equal to or less than twenty (20) (20>N >10), from a view point of experience of the inventors. This is because, the user easily tends to have a doubt about that there still remain other stores or shops than those selected under the condition of not being searched out in spite of convenience thereof, if the number n of stores is less than ten (n <10), while on the contrary to this, the user looses her/his mined in the selection due to much selections thereof if it is greater than twenty (n >20).

In the manner mentioned in the above, in a case where it is decided to find the number of stores being equal to or greater than the predetermined number (N) (i.e., when decided to be “YES”), those stores or shops which are found out are displayed (step S135). Following to this, depending upon the fact that the user inputs the button of “Return” on the store search screen, as show in the above-mentioned FIG. 16, for example, and so on, it is decided that other area being different from that mentioned in the above is selected or not (step S136). As a result of this, in the case that the other area is selected (i.e., when decided to be “YES”), it prompts the user to input the area code (the upper four (4) digits thereof) which the user wishes to have into the item of “Area Code” on the above-mentioned store search screen (step S137), thereby turning back to the above-mentioned step S132, so as to peat the processes mentioned above.

On a while, in the case where it is decided that no other area is selected in the step S136 mentioned above (i.e., when decided to be “NO”), it prompts the user to select one among the predetermined number n of the stores or shops which are found out or detected in the manner mentioned above (step S138).

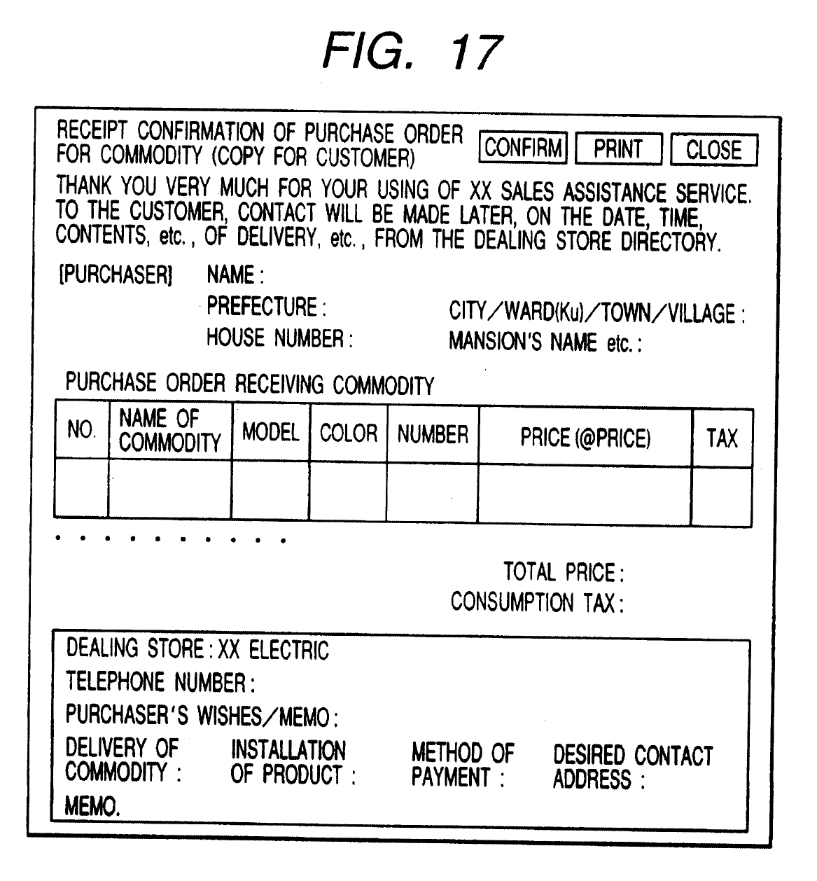

Here, again turning back to the FIG. 8, it is decided whether the one store is selected by the user or not, in the step S14. As a result of this, in the case where the one store is selected (i.e., when decided to be “YES”), so-called the order receipt confirmation screen, such as shown in the FIG. 17 attached, for example, is displayed on the PC terminal, so as to prompt the user to make the confirmation thereof (step S15), and then it is decided whether the confirmation is made or not (step S16). Thereafter, in a case where the above-mentioned order receipt screen is confirmed (i.e., when decided to be “YES”), the contents thereof is memorized into the order receipt database 353 of the above-mentioned memory device 350, as the order receipt file (see the FIG. 6), thereby completing the process. However, when it is decided to be “NO” in the above-mentioned steps S14 and S16, the process is completed as it is.

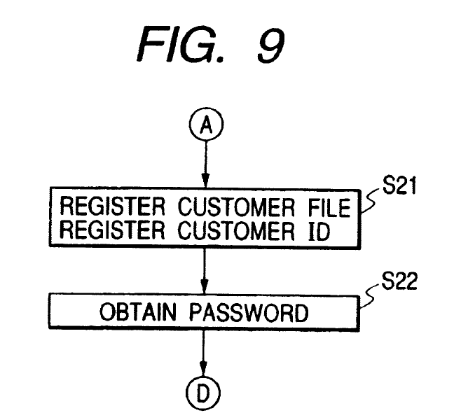

Following to the above, the flow (A) which is shown in the FIGS. 7 and 8 will be indicated in the FIG. 9 attached. In this process flow, registering the identification number which the customer input by her/himself as the customer ID (step S21), as well as memorizing the above-mentioned customer file (see the above-mentioned FIG. 3) into the customer database 351 of the memory device 350 mentioned above, and further obtaining the password of her/him so as to register it depending upon the necessity thereof (step S22), the process turns back to a process flow (D) shown in the FIG. 7 mentioned above.

Next, the flow of the order transmission process is shown in the FIG. 11 attached.

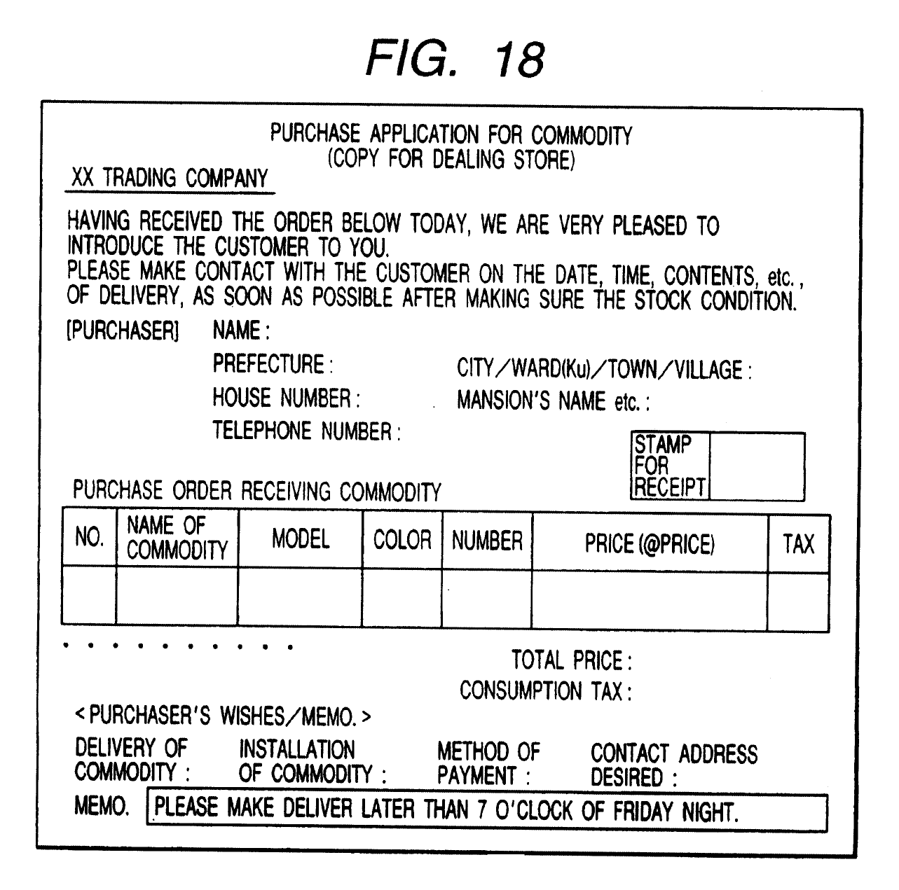

As is apparent from the figure, this flow of the order transmission process is initiated by the fact that the order process flow shown in the above-mentioned FIGS. 7 through 10 is completed (step S31), and it is for the purpose of transmitting the receipt of application of the purchase order for goods or commodity which is inputted, to the store which is selected in the processes mentioned in the above. Namely, after the process is initialized by the above-mentioned step S31, the sales assistance server 30 produces data for use in facsimile transmission, as be an order receipt data, upon the basis of the order receipt file memorized in the order receipt database 353 and the store file memorized in the store database 354 of the above-mentioned memory device 350 (step S32). Further, as an example of this data for facsimile transmission can be utilized the screen of the purchase order application of commodity, as shown in FIG. 18, here.

Thereafter, this sales assistance server 30 transmits the above-mentioned data for facsimile to the selected store by using a build-in facsimile modem (step S33). And, after confirming the condition of transmission on the above-mentioned data for facsimile transmission (step S34), as a result of this, if it is decided to be OK (i.e., when decided to be “YES”), a sign or mark indicating the completion of transmission thereof (i.e., a transmission completion sign) is added, for example, to a portion of the above-mentioned data for facsimile transmission, thereby completing that process.

Although not shown in the figure herein, it is not necessary the data for facsimile transmission, as the screen of the purchase application for commodity which is produced in the above-mentioned order transmission process, must be transmitted through the build-in facsimile modem, but it may be transmitted to the selected store through the computer network in the place thereof, for example, or it may be sent to the selected store by using a facsimile machine or apparatus after being printed out on paper once.

In this manner, according to the sales assistance system according to the present invention, wherein the store or shop handling the goods or commodity which the customer wishes to buy is selected among the plural number (20>N >10) thereof, by using the computer networks, the customer is able to select the store or shop which is located at the most suitable or convenient seat or location for her/himself. Also, to that selected store or shop, at the same time of the selection thereof, is transmitted the purchase order data which is inputted by the customer, therefore that store or shop selected can know or notice the purchase order data from the customer, immediately. Namely, according to this, after confirming the receipt of the purchase order thereof, the selected store or shop may waits for visit by the customer, or may visit the customer, while preparing the goods or commodity on which the purchase order application is made. For this, it is possible for the customer to obtain the goods or commodity on her/his desire as soon as possible, with checking or ascertaining the actual goods by her/himself, thereby being very convenient, in particular for the customers who cannot visit the stores or shops by themselves, such as old aged peoples, handicapped peoples, etc., for example.

Also, with using the area code of the telephone number(for example, the upper four (4) digits thereof) within the address relating information of the customer, in particular when searching the stores or shops mentioned in above in the plural number thereof, it is possible to realize or achieve the search of the stores or shops which handle the goods or commodity to buy, located in the neighborhood of the address of the customer or of the delivery address thereof, with a simple calculation process thereof.

As is apparent from the detailed explanation given in the above, with the sales assistance system and the method thereof with using the computer networks, according to the present invention, since the customer is able to buy the goods or commodity after ascertaining it/them via the stores or shops locating in the neighborhood, the user can purchase the goods or commodity with using the computer networks, but without feeling anxiety thereabouts, thereby achieving superior effects on promoting the utilization of the computer networks, being represented by the Internet, and at the same time, of utilizing the sales system constructed with the conventional stores or shops.

While the present invention has been described in detail and pictorially in the accompanying drawings it is not limited to such details since many changes and modifications recognizable to those of ordinary skill in the art may be made to the invention without departing from the spirit and the scope thereof.

What is claimed is:

1. A sales assistance system, being connected with a plurality of client terminals through a computer network, comprising:
a communication means, being connected with said computer network, for inputting a goods purchase request information including a customer address relating information from said client terminals;
a memory device for storing at least a goods/store information including the goods and the stores which deal with those goods; and
a controller portion for searching a plurality of stores from the goods/store information stored in said memory device, based on said customer address relating information which is inputted through said communication means, so as to display them on one of said client terminals, as well as for detecting the store which is selected by the customer, among those plural stores, so as to transmit the goods purchase request information which is inputted from said client terminal to said store which is detected.

2. A sales assistance system as described in the claim 1, wherein a number n of the plural stores which are searched and displayed upon the basis of said customer address relating information lies within a range from being equal or greater than ten and being equal or less than twenty (10<n <20).

3. A sales assistance system according to claim 1, wherein said controller portion further comprises:
a transmit device which sends the inputted goods purchase request information to said store which is detected.

4. A sales assistance system as described in the claim 1, wherein said transmit device is at least any one of a facsimile modem, a facsimile apparatus and an electronic mail device.

5. A sales assistance system as described in the claim 1, wherein the goods/store information which are stored within said memory device includes image information of the goods which the store are handling.

6. A sales assistance method for assisting sales of goods using a computer system, which is connected with a plurality of client terminals through a computer network, and including a memory device for storing at least a goods/store information including information concerning the goods and the stores which deal with those goods, and a controller portion, said sales assistance method comprising the steps of:
inputting purchase request information including a customer address relating information from any one of said client terminals;
searching a plurality of stores which are dealing with said goods, from the goods/store information stored in said memory device, based on said customer address relating information which is inputted, so as to display them on said client terminal;
detecting the store which is selected by the customer on said client terminal among those plural stores; and
transmitting the goods purchase request information which is inputted from said client terminal to said store which is detected.

7. A sales assistance method as described in the claim 5, wherein a number n of the plural stores which are searched and displayed based on said customer address relating information lies within a range from being equal or greater than ten and being equal or less than twenty (10<n <20).

8. A sales assistance method as described in the claim 6, wherein the transmitting step is conducted using at least any one of a facsimile modem, a facsimile apparatus and an electronic mail device.

9. A server connected to network, comprising:
a communication device connected to network;
a first portion connected to the communication device, receive an order of merchandise from user via network;
a second portion connected to the communication device, to confirm a delivery address to deliver merchandise user ordered;
a third portion connected to the communication device and the second portion, to confirm a shop picked up based on the delivery address; and
a fourth portion connected to the first portion and the third portion, to make an application with the order and the shop address.

10. The server connected to network according to claim 9, wherein said application having a signature area for testifying receiving correctly.

11. A server connected to network, comprising:
a communication device connected to network;
a first portion connected to the communication device, to receive an order of merchandise from user via network;
a second portion connected to the communication device, to confirm a delivery address to deliver merchandise user ordered;
a third portion connected to the communication device and the second portion, to confirm a shop picked up based on the delivery address;
a fourth portion connected to the first portion and the third portion, to make an application with the order and the shop address; and
a transmitting device connected to the fourth portion, to transmit the application to the shop specified the shop address.

12. The server connected to network according to claim 11, wherein said application having a signature area for testifying receiving correctly.

13. A method for assisting sales using network, comprising the steps of:
receiving an order of merchandise from user via network;
confirming a delivery address to deliver merchandise user ordered;
confirming a delivery address to deliver merchandise user ordered;
confirming a shop picked up based on the delivery address; and
making an application with the order and the shop address.

14. The method according to claim 13, further comprising the step of:
transmitting said application to the shop confirmed by user.

15. A computer readable storing a medicum having stored thereon a computer program for assisting sales using network, the program when executed on server causes the server to perform the steps of:
receiving an order of merchandise from user via network;
confirming a delivery address to deliver merchandise user ordered;
confirming a shop picked up based on the delivery address; and
making a confirmation with the order and the shop address.

16. The computer program according to claim 15, when executed further causes the server to perform the step of transmitting said application to the shop confirmed by user.
